(19) United States
(12) Patent Application Publication
(10) Pub. No.: US 2010/0116859 A1
(43) Pub. Date: May 13, 2010

(54) DIAPER BAG

(76) Inventors: Tamar Ayelet Dessou-Tzafrir, TEL AVIV (IL); Eyal Dessou-Tzafrir, Telaviv (IL)

Correspondence Address: DEBORAH A. GADOR, P.O. BOX 4133, GANEL TIKVA, 55900, IL

(21) Appl. No.: 12/532,835

(22) PCT Filed: Mar. 27, 2008
(86) PCT No.: PCT/IL08/00420

§ 371 Date: Dec. 22, 2009

Related U.S. Application Data
(60) Provisional application No. 60/908,196, filed on Mar. 27, 2007.

(51) Int. Cl. B60R 7/00; B65D 30/22; B65D 33/14

(52) U.S. Cl. 224/409; 383/38; 383/22

(57) ABSTRACT

The present invention relates to a diaper bag having a top opening and including at least one compartment, each compartment having an access opening and a see-through window permitting viewing of all contents of the compartment and removal thereof. The bag is being constructed and operative to fold so as to cover the see-through window while permitting access to each compartment via said top opening. The bag further includes means associated with the bag for indicating the contents of the bag.

### FIELD OF THE INVENTION

The present invention relates to bags for holding baby accessories.

### BACKGROUND OF THE INVENTION

Parents and care givers require a diaper bag for carrying baby accessories, such as clean diapers and changes of clothing. Almost all conventional diaper bags offer some kind of compartmentalization to help organize the contents. However, with all of them the end result is similar: Before leaving the house one must empty the contents of the bag, because it is impossible to see everything inside. Then one must check what was already in there and go over a “list” in the parents' heads of what must be added. Not only is this so-called “list” completely brand new (especially for first-time parents), long and hard to remember, it often must be done with a crying baby in one hand. Often, this takes a long time, and something is forgotten, anyway.

None of these conventional bags can actually help a parent remember what must be taken and easily and quickly load the bag before leaving the house. Nor do they provide the ability to quickly examine the contents of the bag along with a system that reminds the parents what should be in the bag, saving a lot of time.

One solution is proposed in U.S. Pat. No. 6,176,356 to Powley. This patent discloses a round tote bag for carrying baby items needed to diaper an infant at a remote location. This bag includes a round central vinyl portion on which a baby can be laid, surrounded by a plurality of dedicated compartments of selected shapes and sizes for holding specific baby items, such as bottles.

Some conventional diaper bags offer a separate compartment for parents' articles (such as keys, papers, change, etc.). Others have separate bags that are merely thrown in the main bag with everything else. When a parent needs to get something out of the separate bag, he or she must first open the main bag, locate the smaller bag, and then open the separate opening of the smaller bag. Other bags offer a separate parent bag, however it is not located in a compartment of the bag. It is attached with snaps or other fasteners to the outside of the bag, which is too inviting for theft.

### SUMMARY OF THE INVENTION

The present invention provides a diaper bag that overcomes the disadvantages of conventional bags, without compromising the regular functionality of the diaper bag. Several variations of basically the same concept are described and illustrated herein.

There is provided according to the present invention a diaper bag having a top opening and including at least one compartment, each compartment having an access opening and a see-through window permitting viewing of all contents of the compartment and removal thereof. The bag is being constructed and operative to fold so as to cover the see-through window while permitting access to each compartment via said top opening.

According to a preferred embodiment, the diaper bag further including means associated with the bag for indicating contents of the bag.

According to another preferred embodiment, the diaper bag includes at least one closable flap for covering the see-through window and securing the access opening.

According to another preferred embodiment, the diaper bag includes at least one closable flap for covering said see-through window and securing said access opening.

According to another preferred embodiment, the closable flap includes at least one compartment.

According to another preferred embodiment, the bag includes releasable gripping means for releasably gripping the closable flap in the close orientation of the bag.

According to another preferred embodiment, the diaper bag includes a removable pouch, adapted and configured to seat, while open, in one of the compartments, and to be closed upon removal from the compartment.

### BRIEF DESCRIPTION OF THE DRAWINGS

The present invention will be further understood and appreciated from the following detailed description taken in conjunction with the drawings in which:

FIG. 1a is an illustration of a front view of a diaper bag in a close orientation constructed and operative in accordance with one embodiment of the present invention for wearing as a backpack;

FIG. 1b is an illustration of a top view of the diaper bag of FIG. 1a in a “regular” top open orientation;

FIG. 1c is an illustration of a front view of the diaper bag of FIG. 1a in a “see-all” open orientation;

FIG. 1d is an illustration of a front view of the diaper bag of FIG. 1a in a “see-all” wider opening option orientation;

FIG. 1e is an illustration of a partial front view of the diaper bag of FIG. 1a in a “see-all” list open orientation;

FIG. 1f is an illustration of a pouch for removably placing in a diaper bag in accordance with an alternative embodiment of the present invention.

FIG. 1g is an illustration of a diaper bag mounted on a stroller in accordance with an alternative embodiment of the present invention.

FIG. 2a is an illustration of a front view of a diaper bag in a close orientation constructed and operative in accordance with an alternative embodiment of the present invention for carrying over a shoulder;

FIG. 2b is an illustration of a top view of the diaper bag of FIG. 2a in a “regular” top open orientation;

FIG. 2c is an illustration of a front view of the diaper bag of FIG. 2a in a “see-all” open orientation;

FIG. 2d is an illustration of a front view of the diaper bag of FIG. 2a in a “see-all” wider opening option orientation;

FIG. 2e is an illustration of a partial front view of the diaper bag of FIG. 2a in a “see-all” list open orientation;

FIG. 2f is an illustration of a pouch for removably placing in a diaper bag in accordance with an alternative embodiment of the present invention.

FIG. 2g is an illustration of a diaper bag mounted on a stroller in accordance with an alternative embodiment of the present invention.

FIG. 3a is an illustration of a front view of a diaper bag in a close orientation constructed and operative in accordance with another alternative embodiment of the present invention for wearing as a backpack;

FIG. 3b is an illustration of a front view of the diaper bag of FIG. 3a in a “see-all” open orientation;

### DETAILED DESCRIPTION OF THE INVENTION

The present invention relates to a diaper bag implementing a novel method (the “see-all” concept) for viewing its contents, organizing them, loading the bag and remembering everything that needs to be in it. A number of possible variations on this specific solution for future designs will also be described.

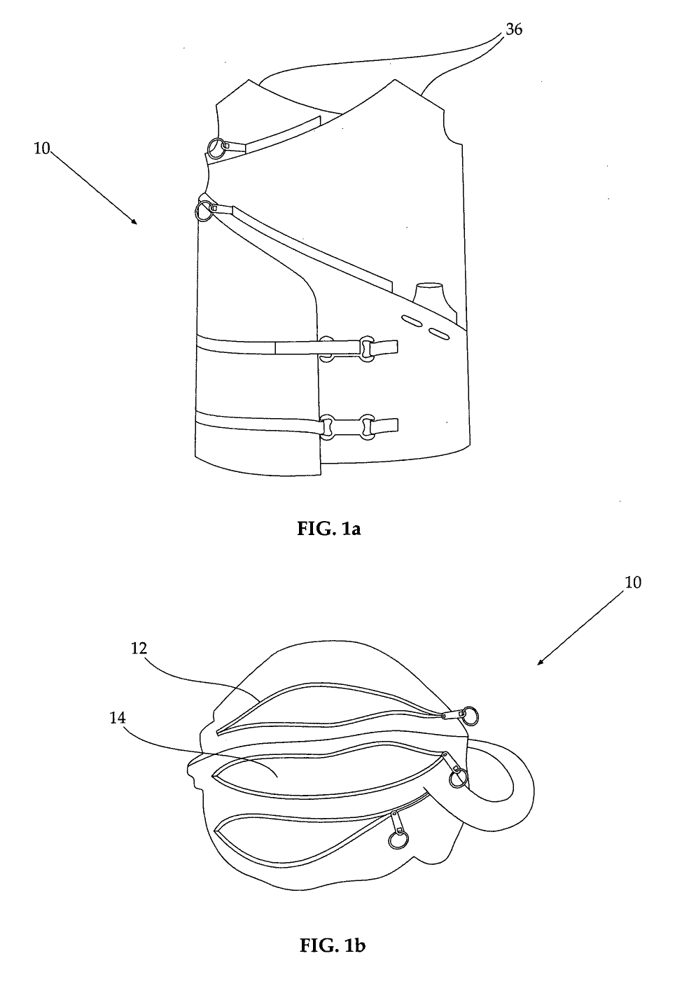

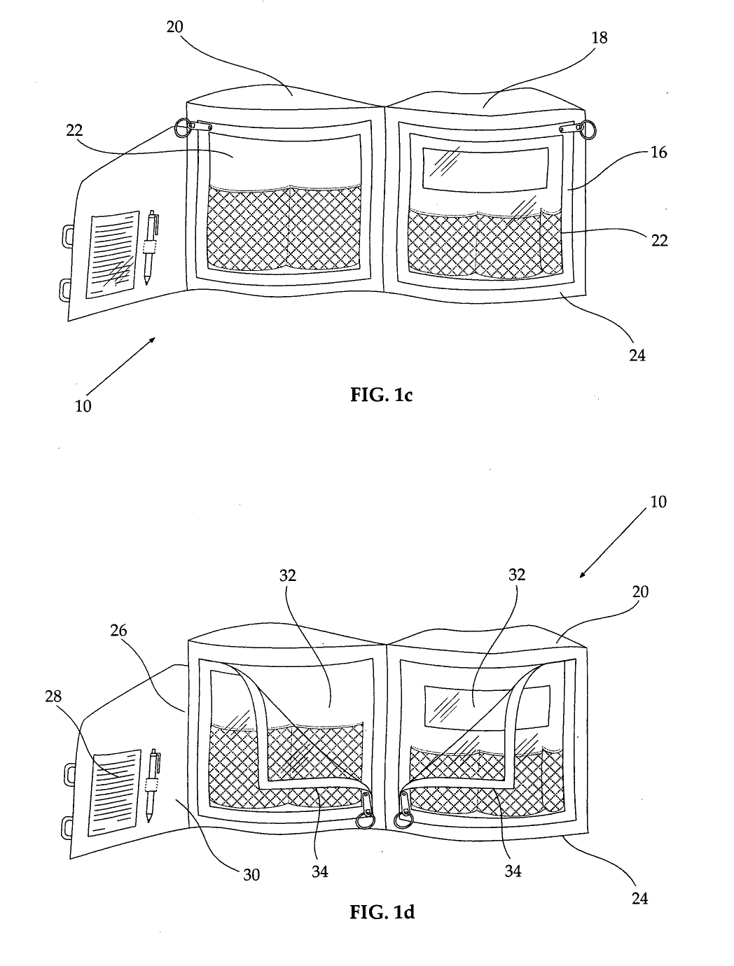

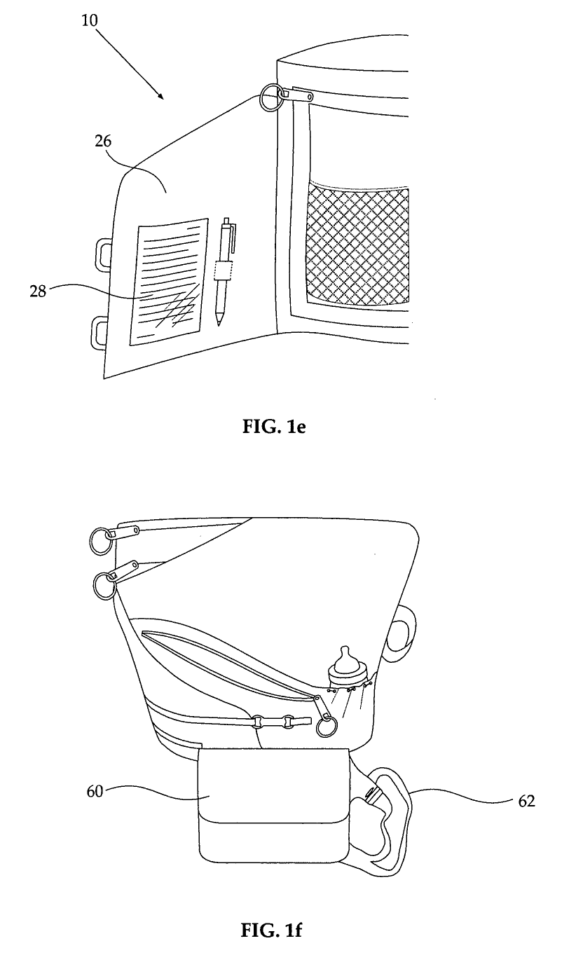

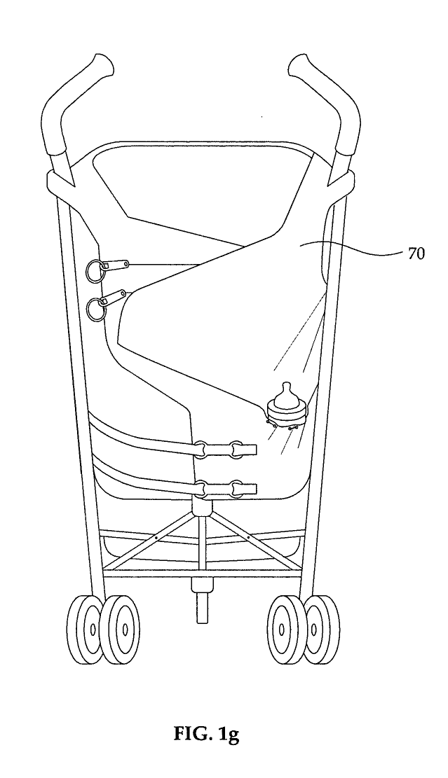

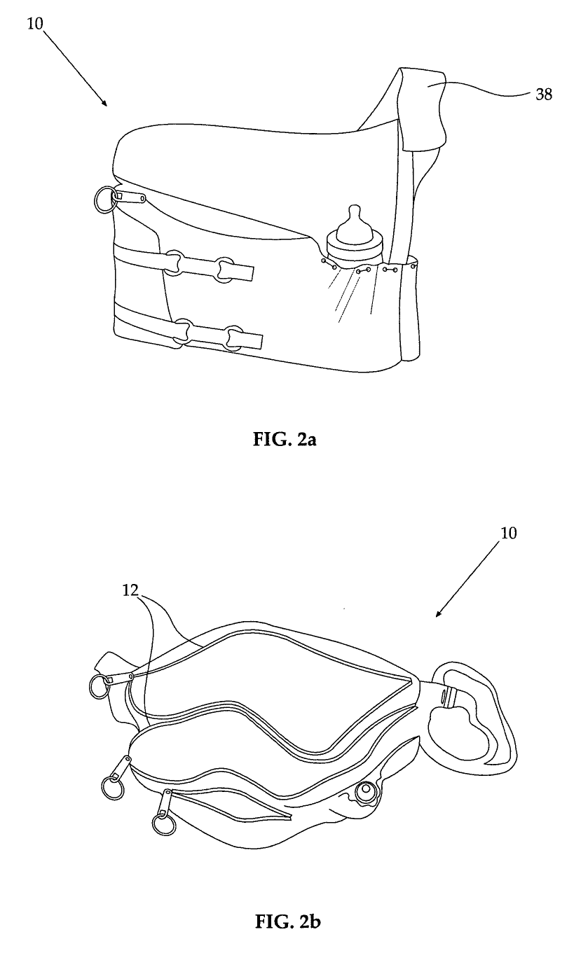

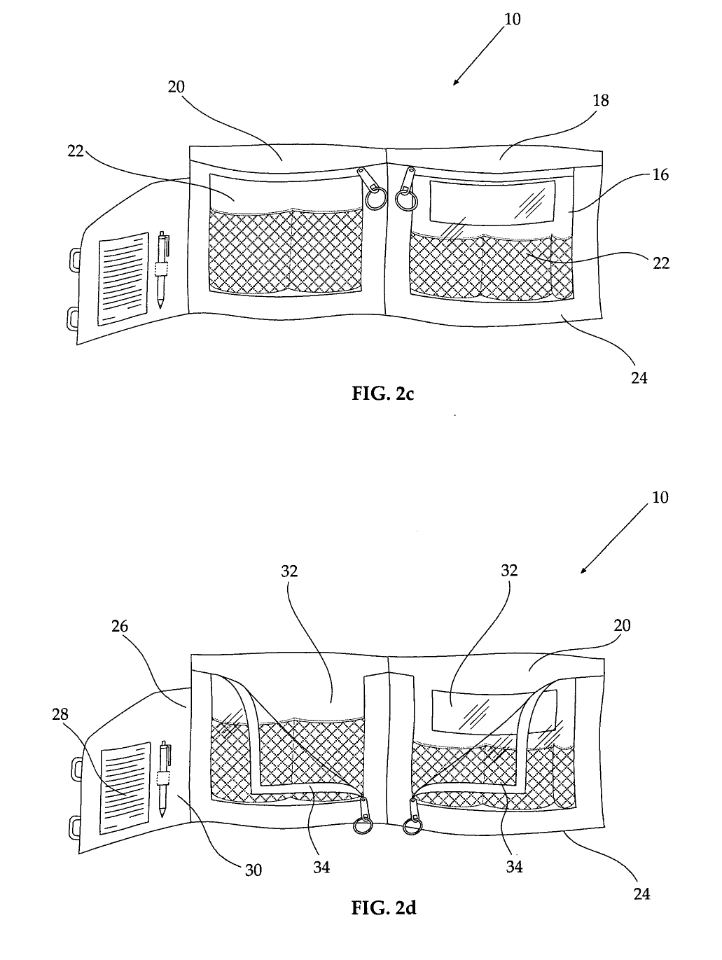

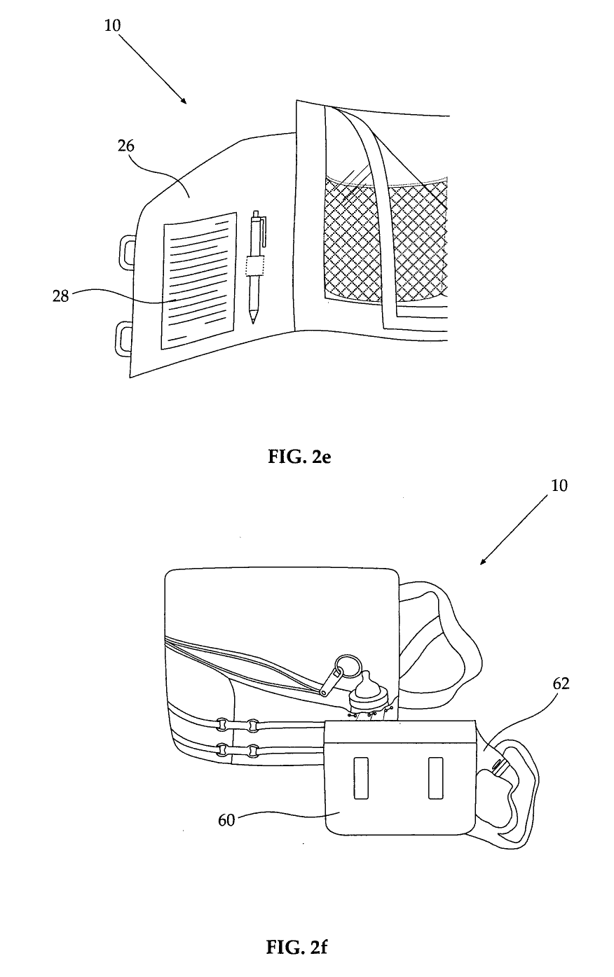

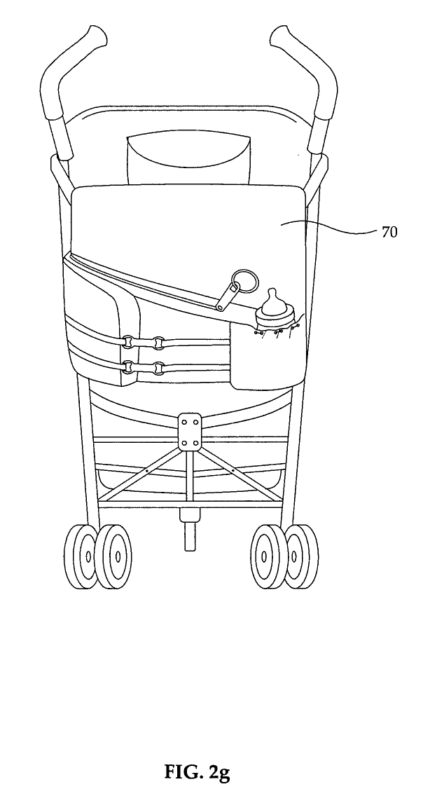

The “see-all” concept of the present invention is directed at providing two different ways of getting to the contents of a diaper bag 10—a “regular” way and a “see-all” way. The “regular” way is illustrated in FIGS. 1b and 2b, where one either opens a zipper or zippers 12 or lifts a flap and reaches inside bag 10 from the top access opening 14 of the bag for removing whatever one desires. The “see-all” way is illustrated in FIGS. 1c, 2c and 3c, where one unfolds diaper bag 10, e.g., opens a side flap 16 and reaches the contents of the bag through a top access opening 18 of one or more compartments 20 formed in the bag and on the side flap. Each compartment 20 includes a “see-through” window 22 in the front sidewall 24 of the compartment. The “see-through” window 22 allows the user to see all the contents in the bag at a single glance as well as to remove whatever he/she desires. Access opening 18 of compartment or compartments 20 is in the same orientation as the “regular” top opening 14 of bag 10, thus the contents of the bag remain in the same direction. This feature is of particular importance since there are usually bottles filled with liquids in a diaper bag.

Referring now to FIGS. 1e and 2e there is shown according to a preferred embodiment of the present invention a separate compartment 26 having a sidewall with a “see-through” window 28 for placing a list of the bag's contents and/or a dry erase marker 30 which may be used to write directly on window 28 and/or windows 22. Such list and/or marker 30 may help the user remember what to place in the bag, and permit him/her to quickly check if an item is missing. Such feature is extremely helpful since usually more than one caregiver uses the bag. It helps create a system wherein any user knows what and where items are placed in the bag.

According to yet another preferred embodiment of the bag, a wider access opening 32 of compartment 20 is provided as illustrated in FIGS. 1d and 2d. One side 34 of front sidewall 24 of compartment 20 is adapted and configured to being opened from its side 34. Side 34 may be attached to compartment 20 by a releasable adhesive material, such as Velcro, zipper, etc. This wider access opening provides for easier filling of bag 10 and access to its contents. When side flap 16 is folded away and the bag is in a close orientation, the user may access the contents of the bag simply through top opening 14 of the bag, i.e. the “regular” way.

As illustrated in FIG. 1a, bag 10 may further include a pair of straps 36 for carrying the bag as a backpack around both shoulders or as illustrated in FIG. 2a bag 10 may include a single strap 38 for carrying the bag as a “messenger bag” around one shoulder.

The bags according the present invention as illustrated and described above open both from the side in the “see-all” way, exposing the “see-through” windows, and from the top opening of the bag in the “regular” way. The bags include a closable flap to cover the “see-through” windows and secure the compartments' access openings. Various conventional releasable gripping means may be used to releasably grip the side flap of the bag in the close orientation. Such gripping means may include a zipper, clips, a releasable adhesive material, such as Velcro, etc.

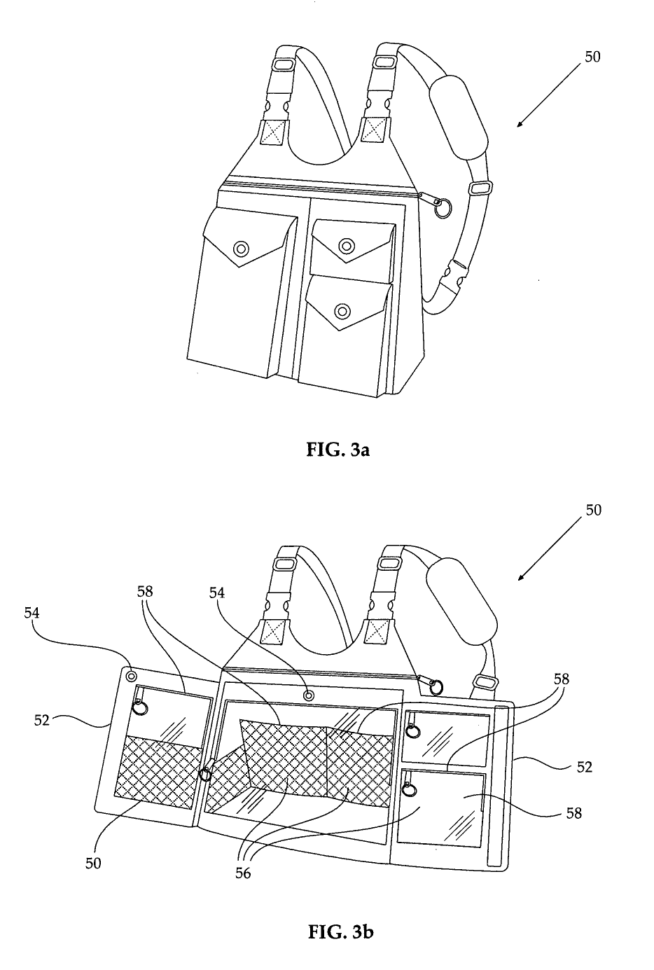

According to another embodiment of the present invention, as illustrated in FIGS. 3a and 3b, bag 50 may include two closable flaps 52 which are adapted and configured to being opened from the center of the bag, in a manner of window shutters. Flaps 52 may be gripped by magnetic snaps 54 or releasable adhesive material such as Velcro, or by a zipper, turn lock, or any other releasable gripping mechanism. When flaps 52 are open as shown in FIG. 3b, transparent or translucent or otherwise “see-through” windows 56 forming the front sidewall of compartments 58, permit viewing of the contents therethrough. It will be appreciate that alternatively the sidewall of the compartments may be formed of “see-through” net as shown in FIG. 3b or other transparent or translucent materials. The front part of the bag may include clear windows, as well, but on their back side. A different opening to these compartments or pockets may be provided for access through the sidewall including the “see-through” windows.

The bags according to the present invention further include a designated area for the user to place a list of what needs to be put in the bag. The user may also write the list directly on the “see-through” window or windows using a dry erase marker, or do both, whichever is more convenient. In this way, the user can customize the bag for her/his personal needs. The list may be located in the bag or alternatively several lists may be attached to specific compartments within the bag. The actual notation can be done in a variety of ways: supply multi use stickers with words or icons on them for the user to stick on the different compartments; do the same but with inserts in slit pockets on the window or the bag's fabric; write directly on the “see-through” window on a pre-printed ornamental background; supply a variety of readymade lists; etc.

According to a preferred embodiment of the invention, the diaper bag further includes a removable pouch 60 illustrated in FIGS. 1f and 2f. The pouch allows the parent/caregiver to keep his essentials separate from the baby's things. Preferably, such essential are located in a separate compartment in the bag. Pouch 60 is removably seated in the compartment and remains open while in the compartment but may be easily closed, removed and carried when needed. For example, when the user is running after his/her child in the park, the user may prefer to leave the heavy bag with the child's things behind in the stroller and carry only his/her valuables in pouch 60. Similarly, when the user wishes to enter a store the user may prefer leaving the heavy bag with the child's things in the car and take only the pouch with the user's valuables. Pouch 60 may include a securing strap 62 for wrapping around the hip or over the shoulder of the user.

As shown in FIGS. 1g and 2g the bags according to the various embodiments of the present invention may be mounted on a stroller 70, thus offering an alternative carrying option for transporting a large and heavy bag, and providing flexibility for the caregiver.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A diaper bag comprising:
a bag having a top opening and comprising at least one compartment, each compartment having an access opening and a see-through window permitting viewing of all contents of said compartment and removal thereof;
said bag being constructed and operative to fold so as to cover said see-through window while permitting access to each compartment via said top opening.

2. The diaper bag according to claim 1, further comprising means associated with said bag for indicating contents of the bag.

3. The diaper bag according to claim 2, wherein said means for indicating includes a compartment in said bag in which to place a list of bag contents.

4. The diaper bag according to claim 2, wherein said means for indicating includes a transparent window on which a list of contents can be written.

5. The diaper bag according to claim 1, further comprising at least one closable flap for covering said see-through window and securing said access opening.

6. The diaper bag according to claim 5, wherein said at least one closable flap comprises said at least one compartment.

7. The diaper bag according to claim 6, further comprising releasable gripping means for releasably gripping said at least one closable flap in the close orientation of the bag.

8. The diaper bag according to claim 1, further comprising at least one strap for carrying the bag.

9. The diaper bag according to claim 1, further comprising at least one strap for mounting on a stroller.

10. The diaper bag according to any of the preceding claims, further comprising a removable pouch, said pouch being adapted and configured to seat, while open, in one of said compartments, and to be closed upon removal from said compartment.

11. A method for making a diaper bag, the method including:
providing a bag having a top opening and defining a plurality of compartments, wherein each compartment is having an access opening and a transparent window;
constructing said bag so as to fold so as to cover said see-through windows while permitting access to each compartment via said top opening; and
providing indicating means for indicating the contents of the bag on said bag.

12. The method according to claim 11, wherein
said step of providing includes providing a compartment for a removable pouch;
the method further comprising:
providing a removable pouch adapted and configured to seat, when open, in said pouch compartment, and to be closed upon removal from said compartment.
